(19) United States
(12) Patent Application Publication
(10) Pub. No.: US 2008/0215686 A1
(43) Pub. Date: Sep. 4, 2008

(54) SYSTEM AND METHODS FOR TRACKING, ANALYZING, AND REPORTING ELECTRONIC MAIL AND ASSOCIATED ELECTRONIC MAIL EVENTS

(75) Inventors: Ian Meredith, Newmarket, NH (US); Michael DesRochers, Newfields, NH (US)

Correspondence Address: MESMER & DELEAULT, PLLC, 1 NEW HAMPSHIRE AVE., SUITE 125, PORTSMOUTH, NH, 03801, US

(73) Assignee: BOOTSTRAP SOFTWARE PARTNERS, LLC, Greenland, NH (US)

(21) Appl. No.: 11/736,317

(22) Filed: Apr. 17, 2007

Related U.S. Application Data
(60) Provisional application No. 60/745,004, filed on Apr. 17, 2006.

(51) Int. Cl. G06F 15/16

(52) U.S. Cl. 709/206

(57) ABSTRACT

A method and computer system for tracking, analyzing and reporting on electronic mail and allows a user to locate and associate electronic mail events to the original electronic mail from within a host electronic mail communication program. The product allows each user to associate electronic mail and associated electronic mail events with an individual electronic mail address. Each electronic mail address is then associated with the user. When the host electronic mail communication program displays an electronic mail, the product identifies the electronic mail address of the sender and displays any previous electronic mail subjects and associated electronic mail events. In addition the product provides methods to allow the user to analyze the pattern of associated electronic mail events and classify the pattern as different types of electronic mail recipient behavior in reports. Further the product provides a recent response report which displays electronic mail events in real-time. The product allows for searching and grouping electronic mail events and associated electronic mail addresses. Delivery of tracked electronic mail may be sent either through the host electronic mail communication program or through the product.

### BACKGROUND OF THE INVENTION

The invention is generally related to electronic mail communication systems and methods. More particularly the invention is relates to a method of providing real-time reports on tracked electronic mail and associated electronic mail events.

### SUMMARY OF THE INVENTION

The invention provides a method and computer product for tracking and reporting on electronic mail and associated electronic mail events; including classifying electronic mail events as other types of electronic mail recipient behavior from within a host electronic mail communication program. Users are provided with methods to track electronic mail and associated electronic mail events from with the host electronic mail communication program.

The Main Toolbar of the product is displayed in the main window of the host electronic mail communication program (Typically the Inbox). The Main toolbar is comprised of buttons allowing for access to functions of the product relating to the main window of the host electronic mail communication program.

The Main Information Panel of the product is displayed within or alongside the main window or Inbox of the host electronic mail communication program. The Main Panel is comprised of two sub-panels the Contact Interactions Panel and the Recent Response panel. This Information Panel may be closed and re-opened by using a button on the Main Toolbar. Each of the subpanels may be minimized or maximized by clicking on the title bar area of the subpanel.

The Contact Interactions Panel displays contact information, electronic mail subjects and events associated with previously sent electronic mail to the address of the sender of electronic mail for the currently selected message in the inbox of the host electronic mail communication program. In addition the Contact Interaction Panel provides links to display detailed records associated with the selected electronic mail address.

The Recent Response Panel provides real-time reports of electronic mail events and displays the electronic mail recipient, time and date of the electronic mail event, subject of the source electronic mail, and type of event. Electronic mail events are displayed in descending order by date.

The Compose Toolbar of the product is displayed in the new message window of the host electronic mail communication program. The Compose toolbar is comprised of buttons allowing for access to functions of the product relating to the compose or new message window of the host electronic mail communication program.

The Compose Information Panel is displayed within or alongside the electronic mail compose/new message window of the host electronic mail communication program. The Compose Panel is comprised of two subpanels, one providing access to contact lists and mailing lists, and the other providing access to a library of saved content, including templates, paragraphs, links, images and file attachments. This Compose Information Panel may be closed and re-opened by using a button on the Compose Toolbar. Each of the subpanels may be minimized or maximized by clicking on the title bar area of the subpanel.

The Lists Sub-Panel displays lists of electronic mail addresses and associated names and contact information from which the user may select some or all to be added as recipients to the current electronic mail message in the host electronic mail program.

The Content Library Sub-Panel displays lists of content that can be selected by the user and then added to the current electronic mail in the host electronic mail program. The user, as well as other users of the system, may also save content to be stored, displayed and made accessible from this sub panel.

### BRIEF DESCRIPTION OF THE DRAWINGS

The invention is better understood by reading the following detailed description of an exemplary embodiment in conjunction with the accompanying figures.

FIG. 1 illustrates the structure and flow of data between the client and server components of the product.

FIG. 2 is a process flow chart of message tracking.

FIG. 3 is a process flow chart of open and forward event tracking.

FIG. 4 is a process flow chart of click event tracking.

FIG. 5 is a process flow chart of received message tracking.

FIG. 6 is a process flow chart of the recent response panel.

FIG. 7 illustrates the Main Toolbar of the system.

FIG. 8 illustrates the functions of Main Toolbar of FIG. 7.

FIG. 9 illustrates tools provided by the Contact panel of the system.

FIG. 10 illustrates tools provided by the Contact tree of FIG. 9.

FIG. 11 illustrates tools provided by the Recent Response Panel of the system.

FIG. 12 illustrates tools provided by the Compose Toolbar of the system.

FIG. 13 illustrates the functions provided by the Compose Toolbar of FIG. 12.

FIG. 14 illustrates tools provided by the Compose Contacts Panel of the system.

FIG. 15 illustrates tools provided by the Content Library of the system.

FIG. 16 illustrates tools provided by the New Communication window of the system.

FIG. 17 illustrates tools provided by the Email Results window of the system.

FIG. 18 illustrates tools provided by the Personalization Menu of FIG. 12.

FIG. 19 illustrates the CAN-SPAM footer of the system.

### DETAILED DESCRIPTION OF THE INVENTION

The invention provides a method and computer product for tracking, displaying and reporting on electronic mail and associated electronic mail events; including classifying electronic mail events as other types of electronic mail recipient behavior from within a host electronic mail communication program. Typical electronic mail events include opens, link clicks, attachment opens, forwards, replies and deletes. Users are provided with methods to track electronic mail and associated electronic mail events from with the host electronic mail communication program.

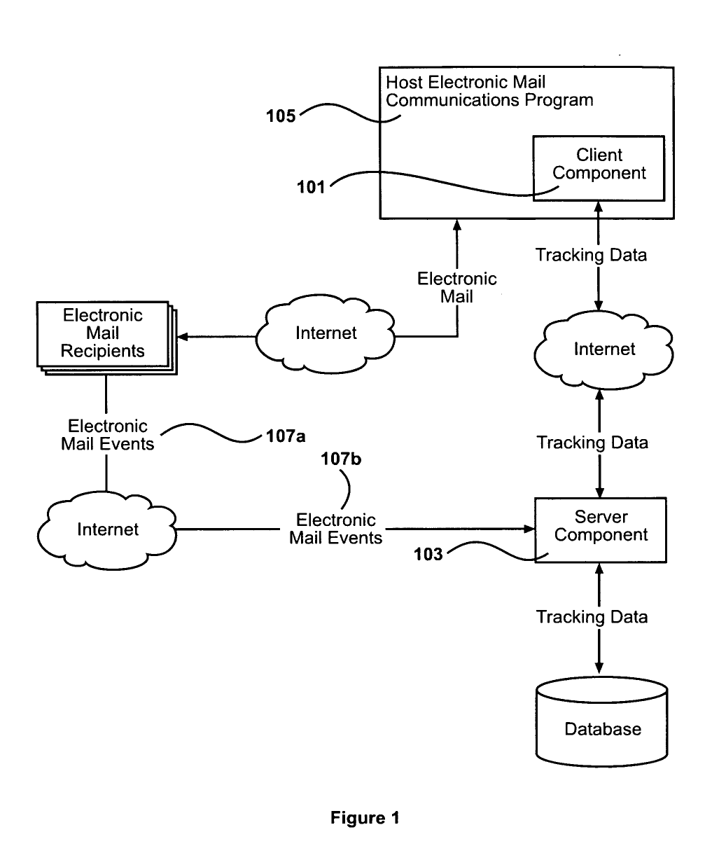

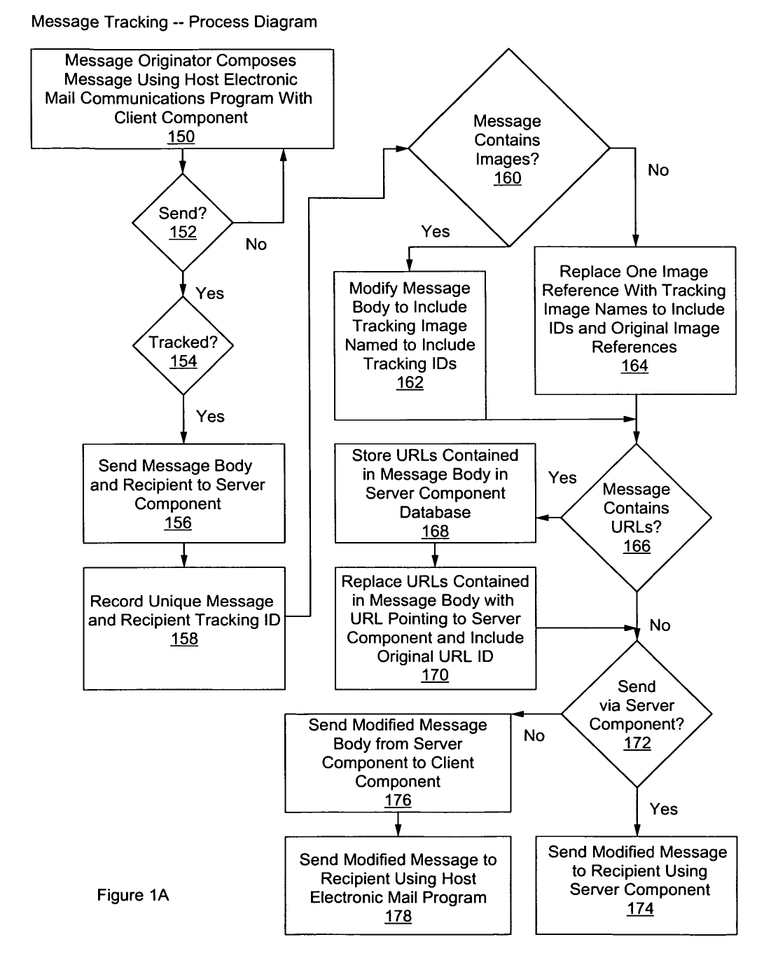

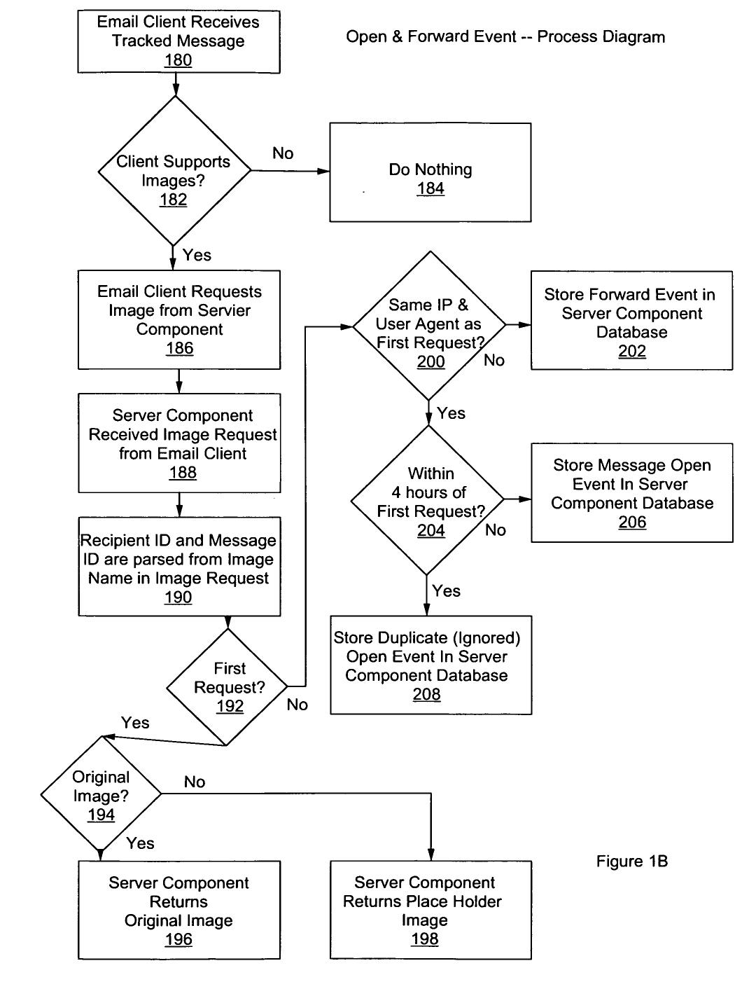

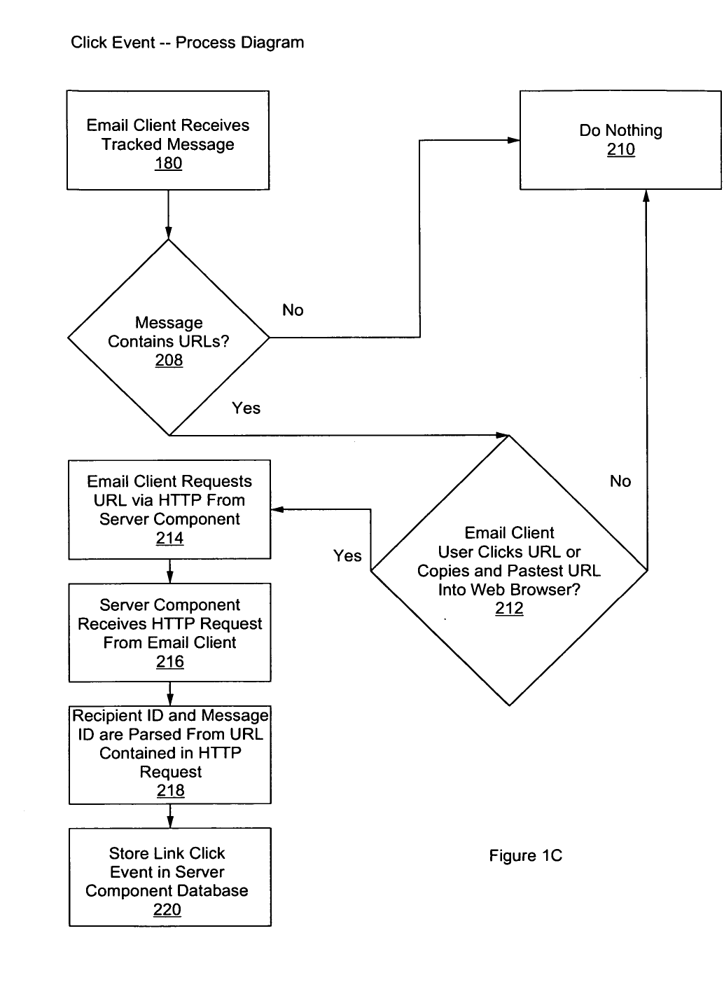

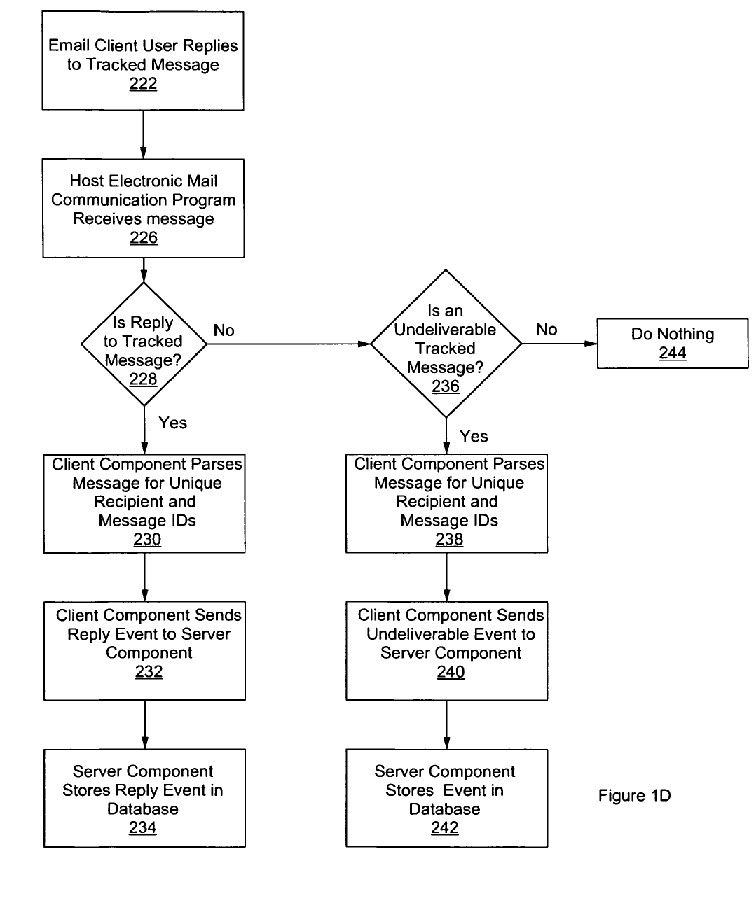

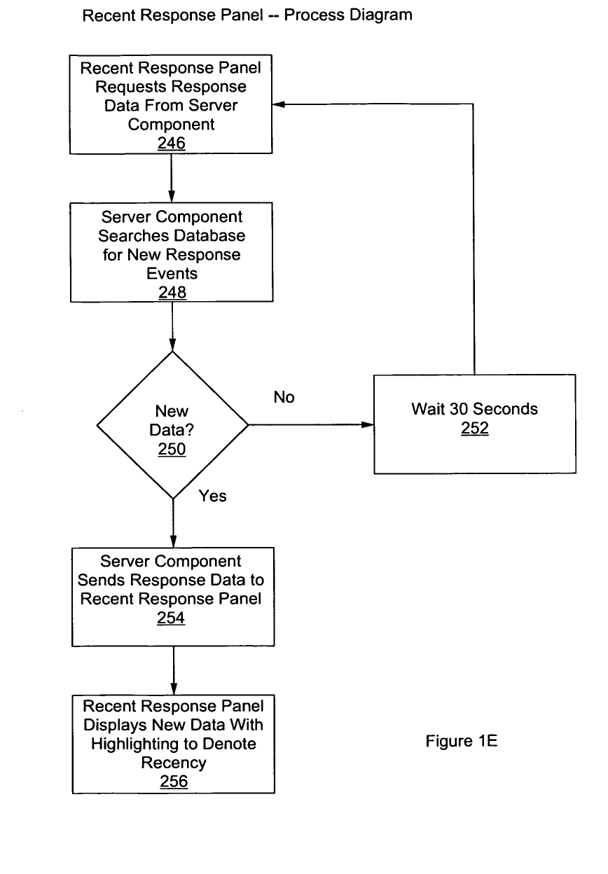

Turning to FIG. 1, the invention is comprised of two components: a client component 101 and a server component 103. The client component 101 is installed within a host electronic mail communications program 105, such as MICROSOFT OUTLOOK 2003, a trademark of Microsoft Corp. The server component 103 is installed on a server computer and used for tracking and recording electronic mail events 107a, 107b.

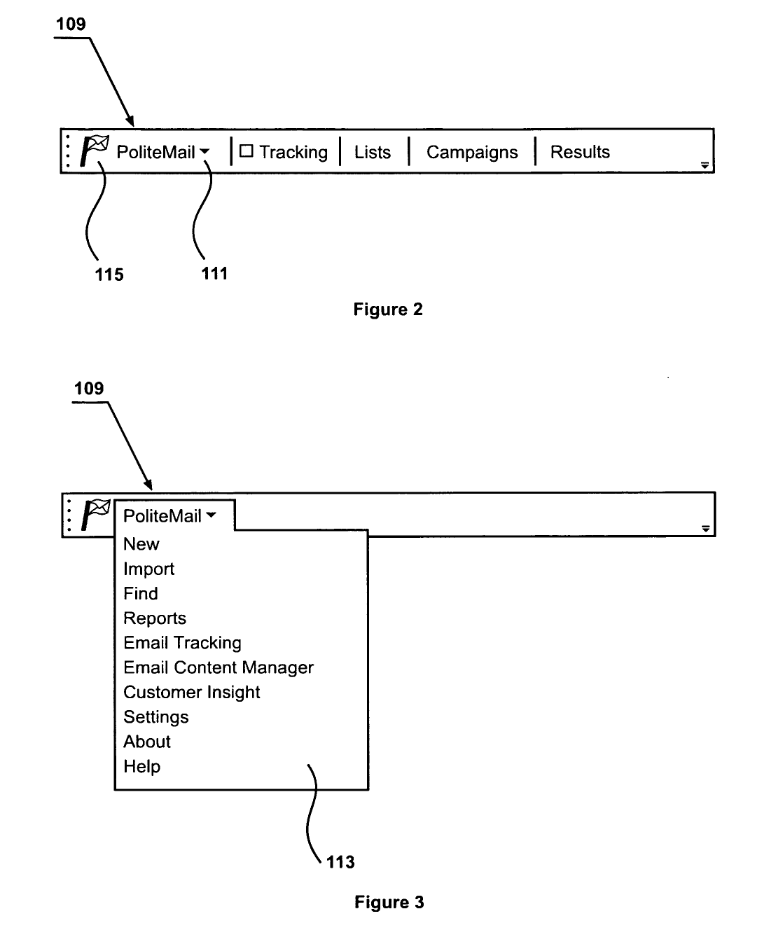

The next five figures are process flow charts showing how the software performs the functions of tracking, analyzing, and reporting electronic mail and associated electronic mail events. Turning to FIG. 2, a message originator composes a message using a host electronic mail communication program with the client component 150. If ready to send 152, then the originator decides whether it is to be tracked 154. If yes, then the program sends the message body and recipient to the server component 156. The server records the unique message and recipient tracking IDs 158. If the message contains images 160, then the message body is modified to include a tracking image names to include tracking IDs 162. If the message does not contain images 164, then one image reference is replaced with a tracking image named to include tracking IDs and original image references 164.

If the message contains URLs 166, then the system stores URLs contained in the message body in the server component database 168. Then it replaces URLs contained in the message body with a URL pointing to the server component and includes the original URL ID 170.

If the message is to be sent via the server component 172, then the system sends the modified message to the recipient using the server component 174. If not, then the system sends the modified message body from the server component to the client component 176. Then the system sends the modified message to the recipient using the host electronic mail program 178.

FIG. 3 describes the “open” and “forward” event tracking feature. An e-mail client receives a tracked message 180. If the client does not support images 182, then the system does nothing 184. If the client supports images 182, then the e-mail client requests an image from the server component 186. The server component receives the image request from the e-mail client 188. The recipient ID and message ID are parsed from Image Name contained in the image request 190. If this is the first request 192, then the system decides whether it is the original image 194. If it is, then the server component returns the original image 196. If not, then the server component returns a place holder image 198.

If it was not the first request 192, then the system decides whether the request is from the same IP and user agent as the first request 200. If not, then the system stores a “forward” event in the server component database 202. If yes, then the system decides whether it is within four hours of the first request 204. If not, then the system stores a “message open” event in the server component database 206. If it is within four hours of the first request 204, then the system stores a duplicate (ignored) “open” event in the server component database 208.

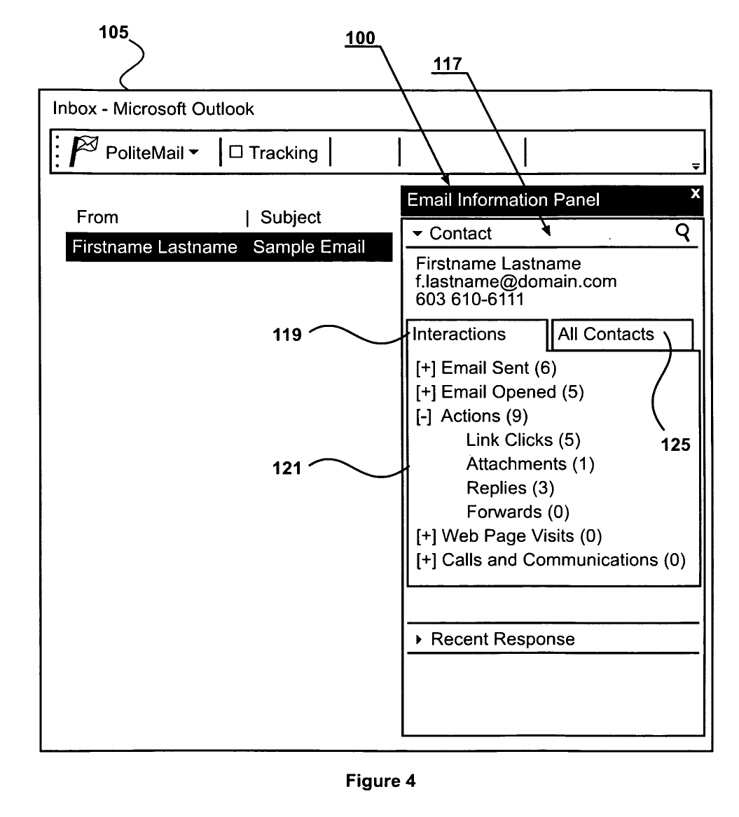

FIG. 4 describes the “click” event tracking feature. First, an e-mail client receives a tracked message 180. The system determines whether the message contains URLs 208. If no, then the system does nothing 210.

If the message contains URLs 208, then the system determines whether the e-mail client user clicks the URL or copies it and pastes the URL into a Web browser 212. If no, then the system does nothing 210. If yes, then the e-mail client requests a URL via HTTP from the server component 214. The server component receives the HTTP request from the e-mail client 216. The recipient ID and message ID are parsed from the URL contained in the HTTP request 218. Then the system stores a “link click” event in the server component database 220.

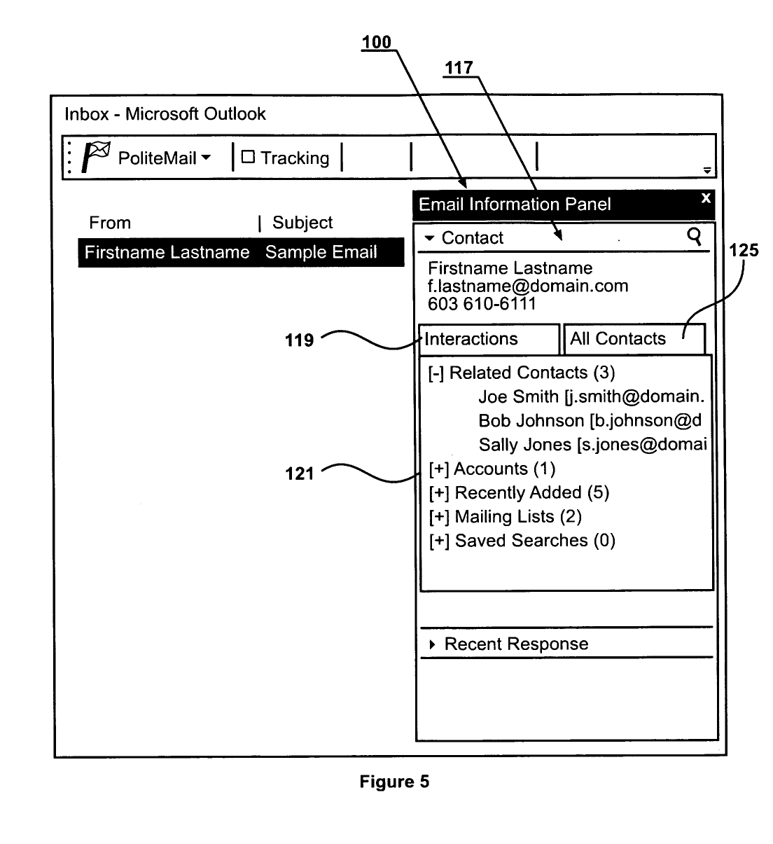

FIG. 5 describes the “received message” even tracking feature. First, an e-mail client user replies to a tracked message 222. The host electronic mail communications program receives the message 226. The system determines whether it is a reply to a tracked message 228. If yes, then the client component parses the message for unique recipient and message IDs 230. The client component sends a reply event to the server component 232. The server component then stores the reply event in the database 234.

If the system determines it is not a reply to a tracked message 228, then the system determines whether it is an undeliverable tracked message 236. If not, then the system does nothing 244. If yes, then the client component parses the message for unique recipient and message IDs 238. Then the client component sends an “undeliverable” event to the server component 240. The server component stores the reply in the event database 242.

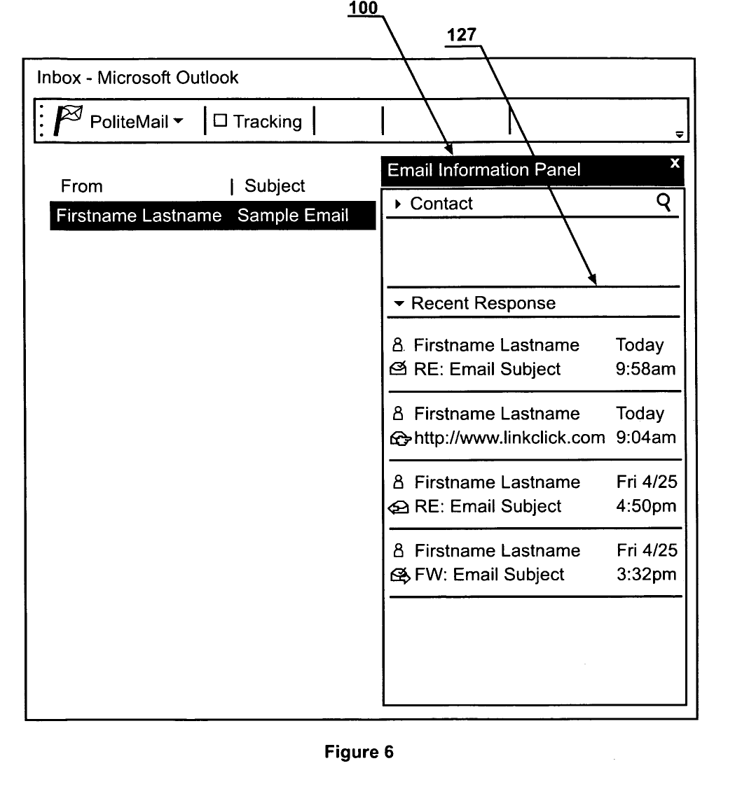

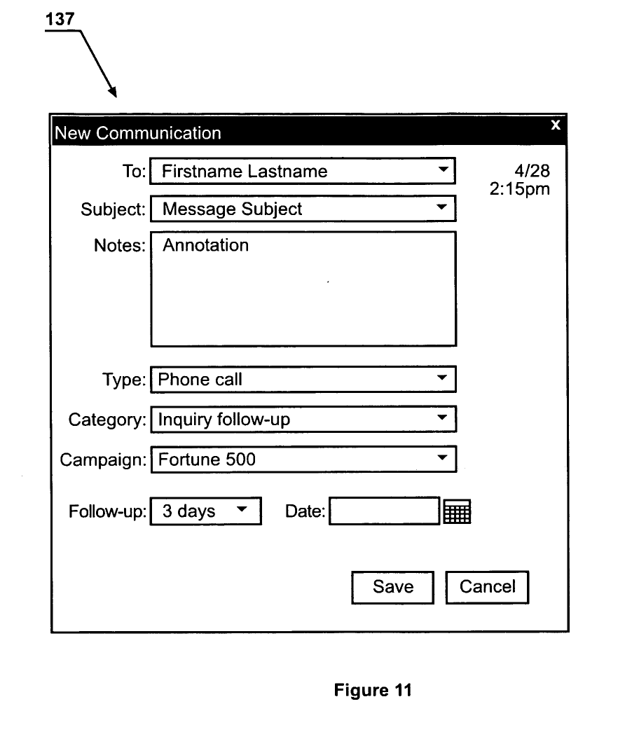

FIG. 6 describes the operation of the recent response panel shown in more detail in FIG. 11. When accessed, the recent response panel requests response data from the server component 246. The server component searches the database for new response events 248. The system determines whether there is new data 250. If no, the system waits 30 seconds 252 and returns to the request process 246. If yes, the server component sends response data to the recent response panel 254. The recent response panel displays new data with highlighting to denote recency 256.

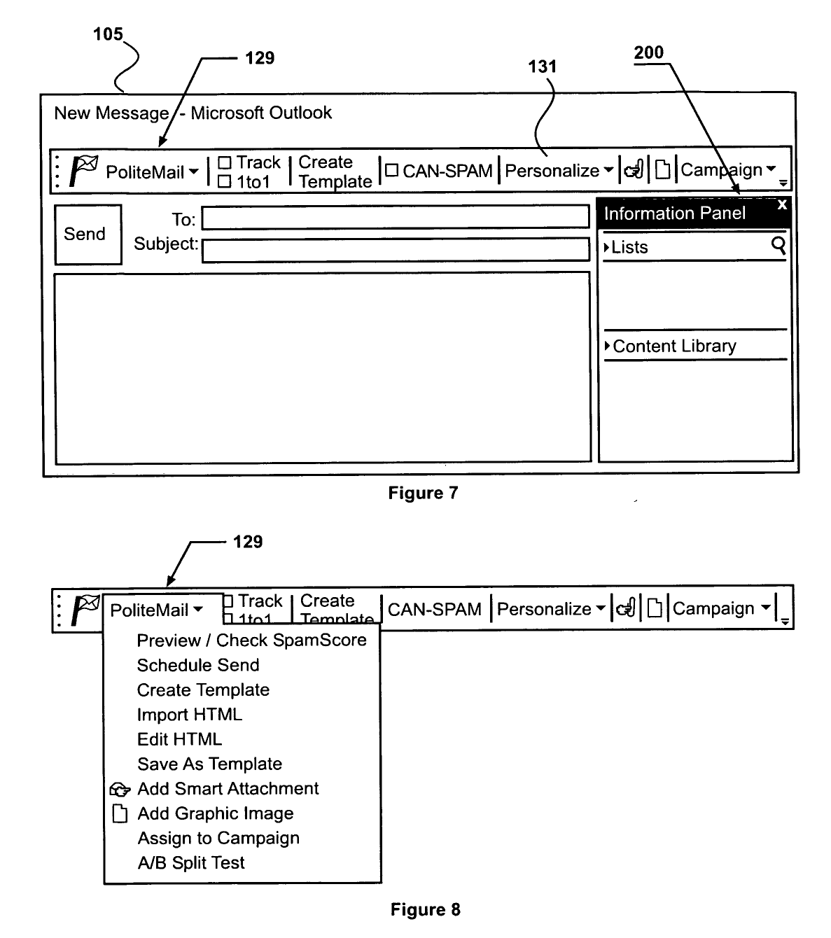

Turning also to FIGS. 7 and 8, the Main Toolbar 109 of the product is displayed in the main window of the host electronic mail communication program 105. The Main Toolbar 109 is comprised of buttons allowing for access to functions of the product relating to the main window of the host electronic mail communication program 105. Click the PoliteMail button 111 on the toolbar to show the dropdown menu of options 113. From this menu a user can create a new contact, mailing list, or campaign; add or import new contacts; manage contacts; see reports related to tracked sent electronic mail, and other electronic mail statistics; manage the items in the Content Library; import new electronic mail content; and change user preferences.

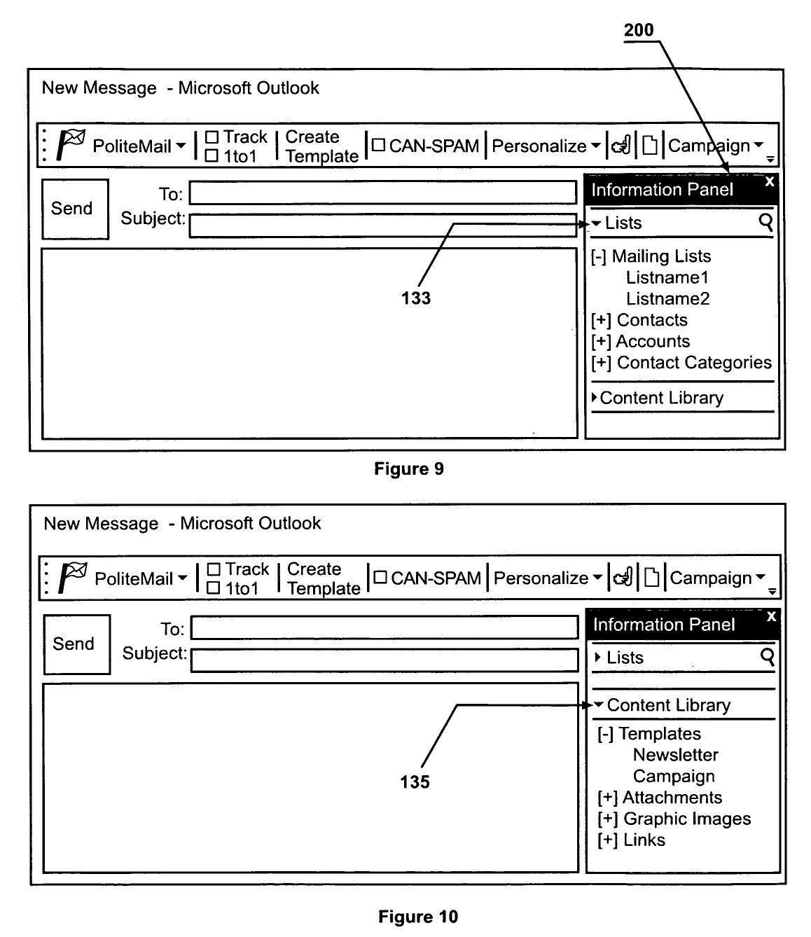

Turning also to FIG. 9, the Information Panel of the product is displayed within the main window of the host electronic mail communication program 105. The Information Panel provides summarized contact information, quick access to tools, and a view into electronic mail events for electronic mail. To hide the information panel, click the flag icon 115. The Information Panel is comprised of the Interactions Panel 119 and the Recent Response panel, item 127 in FIG. 11.

The Contact Panel 117 displays electronic mail subjects and events 121 associated with the electronic mail address of the sender of electronic mail displayed by the host electronic mail communication program 105. In addition, the Contact Panel 117 provides links to display detailed records associated with the selected electronic mail address. The contact panel has two views: interactions 119 and all contacts 125.

Clicking the Interactions button 119 shows contact details related to an active electronic mail item. When one clicks on a new message in your electronic mail communications program, the Contact Panel 117 will display all related information about the sender of the electronic mail. If the sender is not stored in the system, the panel display will give the user the option to add them. See FIG. 9 for a breakdown of the data and functions available from within the Contact Panel 117 when focused on the interactions with an individual contact.

Turning to FIG. 10, clicking the All Contacts button 125 will display the contact folder tree, which includes the user's accounts, contacts, recently added contacts, mailing lists, and saved searches.

Turning to FIG. 11, at the bottom of the information panel is the Recent Response Panel 127. The Recent Response Panel 127 provides real-time reports of electronic mail events and displays the electronic mail recipient, time and date of the electronic mail event, subject of the source electronic mail, and type of event. Electronic mail events are displayed in descending order by date. Each electronic mail event is displayed with the color-coded icon for the contact type, the contact's name and mail address, and the date and time of the electronic mail event (the most recent is at the top of the list). A second line displays an icon signaling the type of response and the subject.

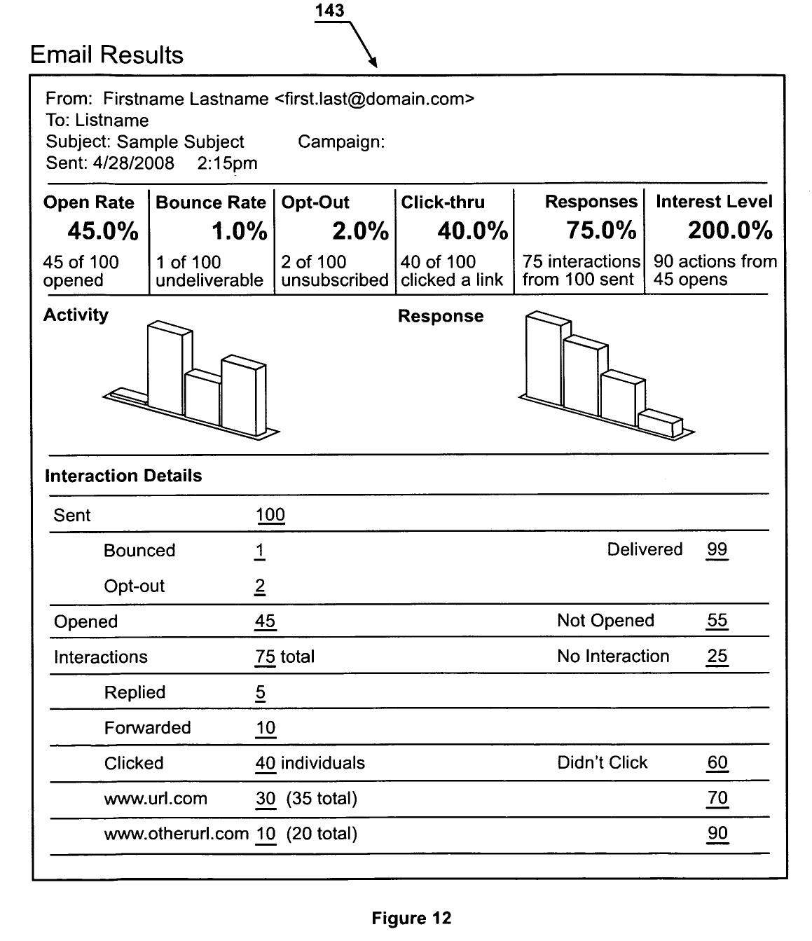

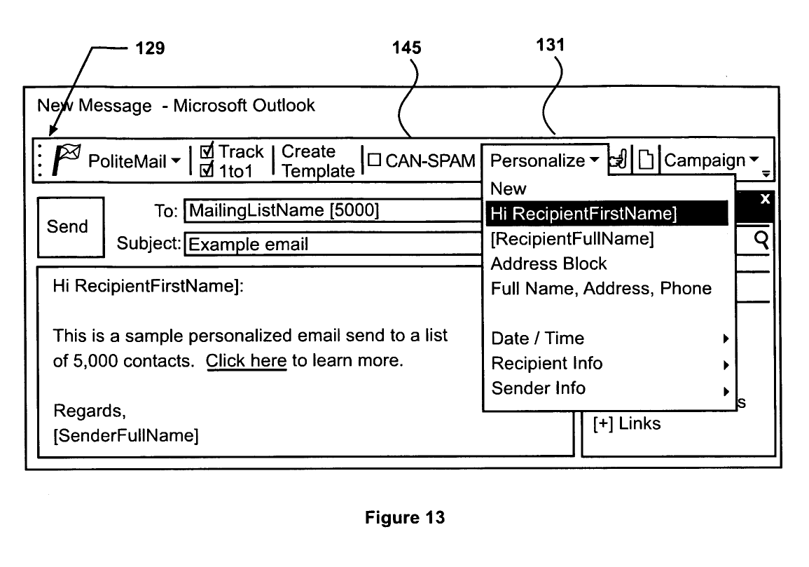

Turning to FIGS. 12 and 13, the Compose Toolbar 129 of the product is displayed in the main window of the host electronic mail communication program. The Main toolbar is comprised of buttons allowing for access to functions of the product relating to the compose window of the host electronic mail communication program 105.

This product makes it simple to personalize the messages users send by using specially formatted merge fields which the PoliteMail product recognizes to bring in data from each specific contact record. A user can click the Personalize button 131 on the Compose Toolbar 129 and choose the merge field or fields from the dropdown menu, and the fields are then inserted into the messageUsers can change the appearance of these merge fields as one would any other text in the body of your message. See FIG. 18 for a breakdown of the Personalization features of the Compose Toolbar 129.

The Compose Panel is displayed within the electronic mail compose or new message window of the host electronic mail communication program 105. The Compose Panel provides access to contacts, mailing lists, and a library of saved content. The Compose Panel can be hidden by clicking the flag icon. See FIG. 6. The Compose panel is divided into two sections, Contacts and Content Library, and both can be minimized or maximized by clicking on their respective title headers.

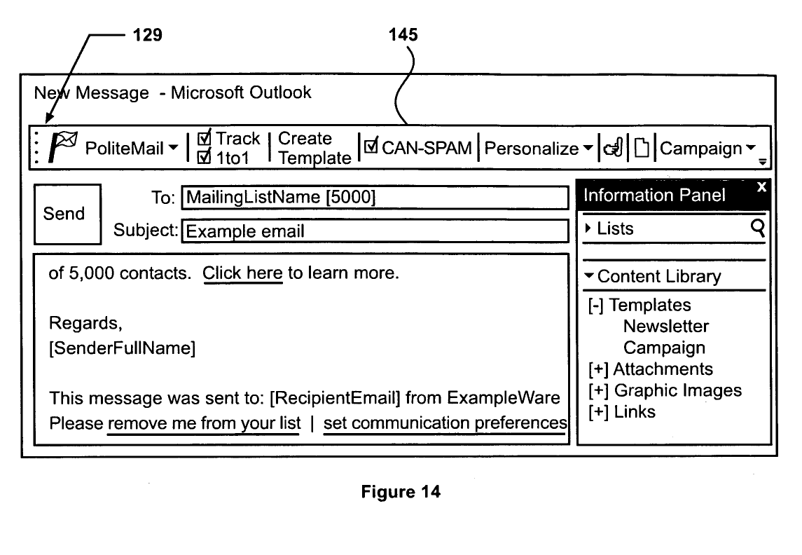

Turning to FIG. 14, the Compose Contacts Panel 133 displays lists of electronic mail addresses and associated names from which the user may select some or all to be added as recipients to the current electronic mail message in the host electronic mail program.

Turning to FIG. 15, the Content Library 135 displays all the electronic mail content shared within the system, as well as the current user's private content. All of which can be selected by the user and then added to the current electronic mail in the host electronic mail program.

Turning back to FIG. 10, users can manage a contact's information through the Contact Detail panel 117. A user can open the panel by focusing on an individual by opening the user's My Contacts folder 125 in the Contact Panel 117 and selecting that person's name from the user's list, or choose an individual from the Recent Response panel 127 of FIG. 11 and clicking Full View from the Contacts panel to open the Contact Detail panel 117.

Users can add and edit general information about their contact under the Contact Info tab 125; track and manage interaction information through the Interactions tab 139.

The Interactions tab 139 displays a list of all the interactions a user has had with a contact. All electronic mail communication and any information entered via the New Communication window 137 is added to this list automatically. See FIG. 16. Users can manage other types of communication (phone calls, faxes, postal mailings, meetings) here as well. To log a new interaction, select New (located next to the Details column header). This will open the New Communication window. From here the user can select the type of communication to create (outbound call, incoming call, meeting, mailing, fax, event, or shipment). Users can select the type of communication, and then click the black arrow to display type-specific details. Once complete and saved, all communications will be displayed in the Recent Response window. See FIG. 16 for a breakdown of the features of the New Communication window.

The Email Results window 143 displays a report of all electronic mail events for either an individual electronic mail or groups of electronic mail within the host electronic mail communications program. See FIG. 17 for a breakdown of the features of the Email Results window.

This product provides a powerful search feature that allows one to segment one's contacts by a wide array of criteria, which is useful in planning appropriate communication strategies for specific target groups or generating reports.

Turning to FIGS. 18 and 19, users can include the CAN-SPAM footer in their message by checking the CAN-SPAM box 145 on the Compose Toolbar 129. The footer includes merge fields that are filled when the message is sent. Users can make changes to the footer (add text, change the font, etc.) in their message, but those changes will not be saved as the default. To save changes, users save the message as a paragraph or template, or edit the default footer. See FIG. 19 for an example of the CAN-SPAM footer.

This product allows for grouping of electronic mail in logical groups called campaigns. Any initiative that has a target goal or objective, and is designed to run during a specific time period, (one week, one month, one quarter, etc.) may be considered a campaign. This product allows a user to track the sent messages, mailing lists, responses obtained in the effort through the campaign detail panel. For example, a user may plan to send a particular mailing list a series of electronic mail messages to encourage the recipients to respond in some way (visit a website, sign up for a seminar, use a coupon, etc.). Messages and mailing lists can be “assigned” to that particular campaign, and one can easily access results, track leads and opportunities, and more all from one central area.

The tracking, displaying and reporting on electronic mail and associated electronic mail events of the invention can be realized in software or a combination of hardware and software. Any kind of computer system or network of computer systems capable of carrying out the methods describe herein is suited. A typical setup would include a web-based server and software server component 103 with a plurality of client computers and software client components 101 running within a host electronic mail communications program 105.

Although the present invention has been described with reference to particular embodiments, it will be apparent to those skilled in the art that variations and modifications can be substituted therefor without departing from the principles and spirit of the invention.

What is claimed is:

1. A method for tracking and communicating electronic mail events comprising the steps of:
providing a client computer program that enables a host electronic mail program to transmit an electronic mail message that can be tracked and communicate electronic mail events;
replacing a hyperlink in the electronic mail message with a tracked link using the client computer program prior to transmission; and
receiving communication of the tracked electronic mail events from a recipient.

2. The method of claim 1, wherein the electronic mail events are at least one taken from the group consisting of opens, replies, forwards, link clicks, attachment opens and deletes.

3. The method of claim 1, further comprising the step of deciding whether to transmit the electronic mail message from the host electronic mail program or the client computer program.

4. The method of claim 1, further comprising the step of storing a record of the electronic mail events on a server.

5. The method of claim 1, further comprising the step of displaying the electronic mail events in real-time.

6. The method of claim 5, wherein the electronic mail events are displayed within the host electronic mail program.

7. A method for tracking and communicating electronic mail events for an electronic mail message sent to a plurality of recipients comprising the steps of:
providing a client computer program that enables a host electronic mail program to transmit an electronic mail message that can be tracked and communicate electronic mail events;
converting a single message addressed to a plurality of recipients into a plurality of messages each addressed to a single recipient;
replacing hyperlinks in the electronic mail messages with tracked links identified to the recipient using the computer program prior to transmission; and
receiving communication of the tracked electronic mail events from a recipient.

8. The method of claim 7, wherein the electronic mail events are at least one taken from the group consisting of opens, replies, forwards, link clicks attachment opens and deletes.

9. The method of claim 7, further comprising the step of deciding whether to transmit the electronic mail message from the host electronic mail program or the client computer program.

10. The method of claim 7, further comprising the steps of:
providing a server; and
storing a record of the electronic mail events on the server.

11. The method of claim 7, further comprising the step of displaying the electronic mail events in real-time.

12. The method of claim 11, wherein the electronic mail events are displayed within the host electronic mail program.

13. A system for tracking and communicating electronic mail events comprising:
a host electronic mail program; and
a client computer program that enables the host electronic mail program to transmit and receive electronic mail messages that can be tracked and to communicate electronic mail events.

14. The system of claim 13, wherein the electronic mail events are at least one taken from the group consisting of opens, replies, forwards, link clicks attachment opens and deletes.

15. The system of claim 13, wherein the electronic mail events are received in real-time.

16. The system of claim 13, further comprising a server that stores records of electronic mail events.

17. The system of claim 13, wherein the client computer program enables a user to transmit and receive electronic mail messages.

18. The system of claim 13, the client computer program comprising a means for processing event information and reporting it according to at least one of time, date, recipient, electronic mail subject, and event.

19. The system of claim 13, the client computer program comprising a means for personalizing electronic mail messages.

20. The system of claim 13, further comprising a means for identifying events to an electronic mail campaign.
